(19) United States
(12) Patent Application Publication
(10) Pub. No.: US 2007/0140176 A1
(43) Pub. Date: Jun. 21, 2007

(54) Method for the transmission of additional information in a communication system exchange device, communication system and user station

(75) Inventor: Michael Bachenberg, Duesseldorf (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Pixcall GmbH, Duesseldorf (DE)

(21) Appl. No.: 10/566,378

(22) PCT Filed: Jul. 24, 2004
(86) PCT No.: PCT/DE04/01663

§ 371 Date: Jan. 26, 2006

(30) Foreign Application Priority Data
Jul. 26, 2003 (DE) 10334208.7
Feb. 16, 2004 (DE) 102004007725.8
Apr. 10, 2004 (DE) 102004017947.6

(51) Int. Cl. H04B 7/216; G06Q 30/00

(52) U.S. Cl. 370/335; 705/14

(57) ABSTRACT

The invention relates to a method for the transmission of additional information in a communication system, whereby a first user (A) in a communication system establishes a communication context for a second user (B) in the communication system, and, during the establishment of the communication context, additional information, for example, in the form of adverts, are connected and transmitted to the second user. The adverts sent during call establishment are used to finance the communication connections. The additional information is sent from an additional information device. An exchange device, a communication system and user stations are embodied for carrying out said method. The users can exchange multimedia data as electronic cards.

The present invention relates to a method for the transmission of additional information in a communication system, whereby a first user of a communication system establishes a communication context with a second user of the communication system in order to exchange information, together with an exchange device, a communication system and a user station.

In communication systems such as those in mobile radio networks or cable-bound networks, speech and data are transmitted between user stations. Such communication systems include, for example, the Internet, cellular mobile radio networks, cabled telephone networks, or even combinations of several types of communication networks.

An example of a cellular digital radio network is the GSM mobile radio network (Global System for Mobile Communication), which is suitable for speech and data transmission. Here mobile user stations are connected by aerial interfaces to a radio transmission system. An exchange system, in most cases with several mobile exchange points and associated visitor registers, serves to transmit signals and data derived from a user station specifically to a desired further user station and to establish the corresponding connection.

The publication WO 9521508 A1 discloses a method for packet data transmission in a mobile radio network, whereby individual data packets are transmitted in traffic channels between mobile radio stations and base stations within a data packet service, namely the GPRS or General Packed Radio Service. In this system existing mobile radio networks may also be widely used for packet data transmission. Here the participating mobile station is allocated a code number by which the traffic channels are identified in control channels as traffic channels containing at least one data packet.

In communication systems, and particularly in modern mobile radio systems, there is an increasing requirement for further expansion of data transmission so that even relatively large data packets, which contain image, audio or video data, for example, can be exchanged quickly between individual user stations of the communication network.

For reducing the signalling load during the transmission of data packets in data transmission in a mobile radio network, the publication DE 19524659 C1 discloses a method for transmitting data packets within a packet data service in which a channel is reserved in the radio transmission system of the mobile radio network, and is linked to a continuous data channel with a transmission channel which leads to a separate services network node.

As a result of the further development of the cellular mobile transmission methods, more and more possibilities are being created for rapid data transmission, even between mobile user stations. An example of this is the UMTS method (Universal Mobile Telecommunication System), which is also ideal for the transmission of multimedia data between user stations of any kind, for example mobile radio sets, PDA's (Personal Digital System), PC, workstation or laptop computers, etc.

In particular, images, audio files, text and video files may be transmitted to a considerable extent from and to mobile radio sets by means of the UMTS method, but unfortunately data transmission in mobile radio networks in most cases involves the users in very high costs.

In order to reduce the costs to the subscribers or users, advertisements may be transmitted to the user stations.

To enable additional information to be recorded in the form of advertising data in a telecommunication system, a method and a device for transmitting additional information to user stations is disclosed in the laid-open specification DE 19940400A1, whereby an additional information device in a connection network establishes an additional communication connection to a calling user so that advertising data can be transmitted to the stations.

However, the methods and systems of prior art suffer from the disadvantage that the advertisements are very often not adequately detected by the recipient. Furthermore, the advertisements are often perceived as disruptive or annoying, or the perception is deliberately suppressed on the user side so that the object of the advertisement is not achieved in many cases.

Although the exchange of large quantities of data and fast data rates are possible in present-day communication networks, and particularly also in the mobile radio sector, the turnovers of the data services, particularly in the mobile radio market, remain far short of the expectations. Neither the mobile Internet portal market nor end customer data services are producing the expected turnover receipts. The methods known hitherto for financing communication services through advertising and mobile marketing, and for making profits from this, have not resulted in the success hoped for or the expected widespread use of such methods, with correspondingly high turnovers.

It is therefore the object of this invention to finance communication connections at least partially by placing advertisements and in doing so ensure more efficient use of them. Moreover, advertisements should be specifically placed to generate added value for users and advertisers. The intention is also to increase the acceptance of advertising among users or subscribers to encourage the increasing use of data services. In particular, operators of communication services should achieve higher turnovers through the specific linking of advertising to communication services. According to a further aspect of the invention, advertising will be placed more efficiently and find more acceptance. According to another aspect, the users or subscribers will make increasing use of communication services, and in doing so will be able to obtain appealing advertising information. Additional communications and advertising information will be perceived in a better light visually without appearing annoying or disruptive.

The object is achieved by the method for the transmission of additional information according to claim 1, by the exchange device according to claim 18, by the communication system according to claim 25, by the user station according to claim 26 and by the control programs according to claims 32 and 33. Further advantageous characteristics, aspects and details of the invention are apparent from the dependent claims, the specification and the drawings.

In the method according to the invention for the transmission of additional information in a communication system, a first user of a communication system establishes a communication connection or a communication context for a second user of the communication system, whereby additional information is connected and transmitted to the second user by an additional information device during the establishment of the communication context.

In this application the term communication connection is also used in the sense of communication context, and vice versa. The terms call set-up, calling set-up or calling signal used here will also be understood to refer to signalling for the establishment of a communication context.

In particular, the additional information in the call set-up or in the negotiation of the communication context may be transmitted and displayed or made visible to the callee, e.g. during the first ringing tone or calling signal. The call set-up therefore becomes the innovatively designable information and communication channel with considerable added value for the user or subscriber. Because additional information is already connected during the establishment of the communication connection, the called subscriber is already made aware of the additional information or advert before or at the beginning of the communication connection.

At the same time the system offers the user the possibility of increased use of the data transmission and of financing it through advertising, whereby advertising is sent as additional information. Data, for example the ID cards explained in the following, are transmitted free of charge to the recipient before the call is accepted through financing with advertising.

Particular advantages to operators are the possibility of additional incomes through the supply of an advertising platform, the connection to the UMTS utility, corresponding advantages in competition and a platform for the operator's own new services and third party services.

The present invention links the calling tone or calling signal to the data reception, even from the Internet or Intranet, for example. Functions may be performed automatically, the call activating the server. In addition, an Internet/Intranet data exchange or the interlinking of different network operators offering such a service, is possible.

For example, the additional information contains data which are indicated on a display of a second user as an individual information unit, particularly in the form of a card, graphically and if necessary also acoustically. Consequently, data such as audio, video, text, image or multimedia data can be linked together, send as an electronic data card and appear in an attractive manner on the displays of user stations. The cards sent in the form of data cards or indicated on displays of user stations are also referred to as ID cards in the following.

The additional information advantageously contains advertising or adverts. Consequently the additional information, in the form of advertising, may reach the second user or recipient in conjunction with a call in the calling signal or in the call set-up, and displayed there. However, the additional information may also be individual data which has been stored by users of the communication service and can be indicated as a data card.

The additional information is advantageously already indicated on the display of a second user during a calling signal, e.g. a ringing tone. Consequently the second user or recipient will perceive the additional information extremely clearly.

Individual user information is advantageously sent by the first user as data to the second user, which data may be indicated on the display of the second user alternately with the additional information, for example as a data card. Consequently the attention of the callee is drawn particularly to the advert.

The additional information preferably contains user information enabling a company, or a special user, to store individual user information as data in an additional information device, which data can be added by certain users to the particular call set-up during the establishment of communication connections so that the calls of these users, linked to individual ID cards, can be transmitted to the appropriate callee.

The first user preferably selects the additional information before its transmission from a number of models. Because of the individual selection of the additional information, e.g. an advert, advertising can be personalised and specifically placed. Because the user selects the advert himself, it becomes a recommendation for his communication partner and is perceived by him with greater acceptance.

For example, the first user dials an additional number or identification to establish the communication connection in order to effect the transmission of advertising or additional information to the second user. This number or identification may be a dialling code, for example.

The additional information or the advert preferably contain a reference to the location of the first or second user which enables location-related advertising or holiday postcards to be sent, for example.

Location-related additional information is preferably selected automatically by the communication system, depending on the location of the first or second user. For example, this enables location-related advertising to refer to supplies of goods or services or sporting or cultural events in the surrounding area of the second user.

At least one of the two users preferably receives bonus points which he can later redeem when advertising is sent as additional information to the second user. Consequently the sending of advertising for the caller has economic advantages, with the result that advertising is increasingly sent to users and the users, for their part, make increasing use of communication services, particularly data communication services.

By entering a specific additional identification the first user can advantageously select desired additional information which is to be sent to the callee. For example, the specific additional identification is attached to products, in which case the corresponding additional information refers to these products so that individual products can be specifically marketed in the communication system. In return for this the caller or callee may receive a cash advantage, e.g. in the form of bonus points which can later be redeemed.

The first or second user can preferably activate a spam filter to prevent the connection of additional information or unwanted additional information. In this case certain types of additional information, for example, which is forbidden to be sent to certain users, can be classified. The additional information is preferably stored in a separate or central additional information device at a central point in the communication system and is sent from there to the second user, together with the call set-up, when the first user establishes a communication connection to the second user.

In particular, the transmission of data or ID cards can also be linked to the sending of short messages or SMS's. This can take place so that the short message or SMS is conventionally called up on the menu of the user, but here the ID card of the sender, and possibly, and alternately with it, the advert, will appear on the callee's display.

There is also a possibility of overwriting or replacing ring tones by music, audio or speech messages. In the case of collisions of data displays, corresponding overwrite functions can be provided which set a priority function for certain reproductions, depending on clearance.

It is also possible to send the advert with the data of a network operator. In this case the provider identification may be an advert, e.g. in the form of a screen saver, which automatically changes at certain intervals.

A high advertising impact is also achieved if the advert remains as a screen saver on the display of the user station, and is seen several times by the user and the people around him. This therefore gives rise to active representation, for example, through the mobile telephone, particularly at home, in the office, in the restaurant, in the bar, etc. Acceptance is increased because the transmission of data, and particularly multimedia data, from and/or to mobile radio units, conforms to the modern spirit of the times.

The present invention also makes possible, in particular, the generation and free of charge sending of ID cards and other data packets via mobile radios. In this case the ID cards may, for example, be freely designable image, text, number and/or speech files which are transmitted simultaneously with the caller identification code and caller ID or user identification to the callee. Simultaneous transmission of additional data to the caller identification code of mobile radios is therefore also made possible.

With a suitable data processing program for mobile user stations, the user is able to store and generate his own ID cards. These may also be assigned to stored numbers. A general ID card can be allocated to all unstored and stored numbers without their own ID card allocation. In this case ID cards or components can be generated and loaded into a terminal device. An overwrite function, for example, enables images with text to be overwritten or supplemented. The numeric caller identification or caller ID is integrated in the ID cards, for example. Mobile networks are also ideal for processing and transmitting such data packets.

Besides the possibility of free of charge generation and sending of data packets, the user also has the possibility of a terminal device discount on clearance, possible exemption from the basic fee, or a reduction in the basic fee, or even a monthly deduction of a certain amount from his telephone bill. However, other benefits, such as discounts or credit notes for goods or services, participation in draws or games of chance, tickets for admission to cultural or sporting events, etc., may be granted to the user.

For advertisers the main advantages are effective global advertising platforms and specific targeting of the advert, since the advertising can be geared regionally, nationally and internationally. Adverts inserted are adapted linguistically, for example, according to the national dialling code. The number of advert recipients and the time the advert remains as a screen server can be measured accurately, for example, when the terminal device is switched on. These figures can be reported statistically and the bills can be settled according to the service rendered.

A specific advert may also be inserted based on age and sex, in which case these data can be given voluntarily or are known from provider contracts.

The invention is described in the following in various examples with reference to the figures, where

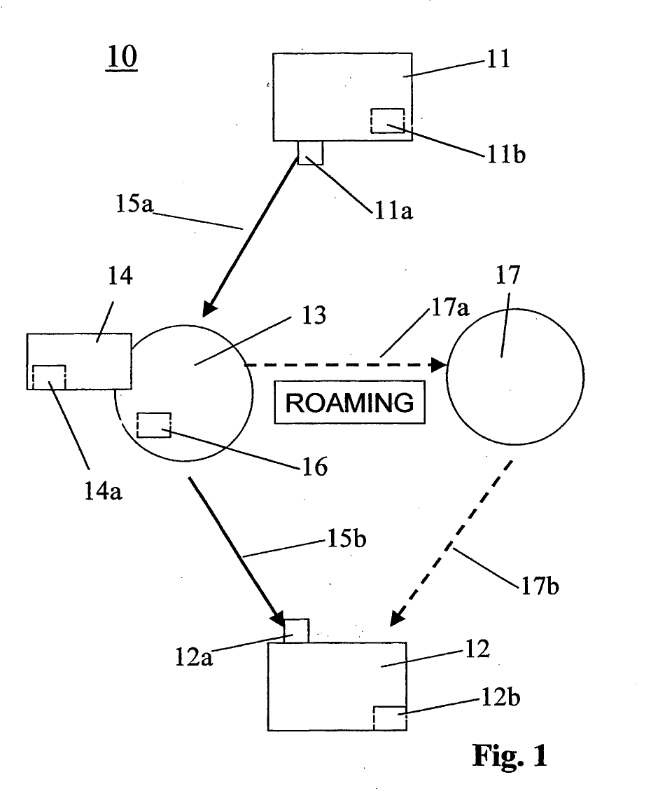

FIG. 1 shows diagrammatically a communication system according to a first preferred embodiment of the invention with which the method according to the invention is carried out;

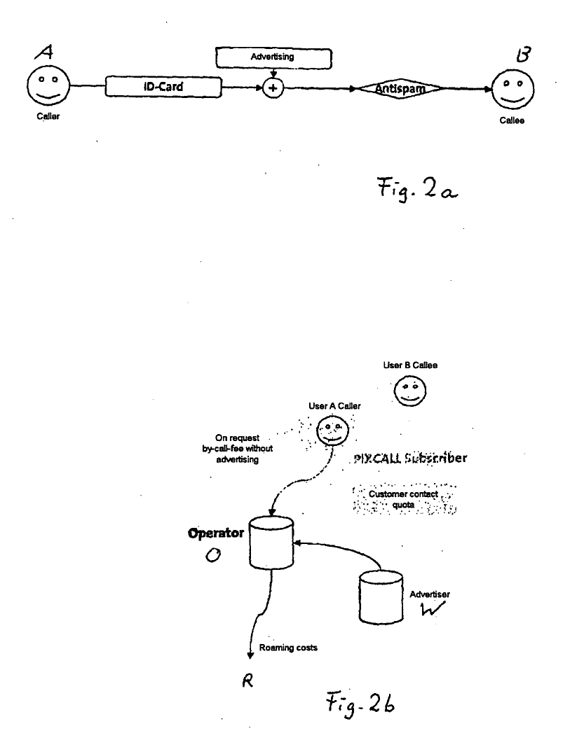

FIGS. 2a and 2b show a first preferred example of the method;

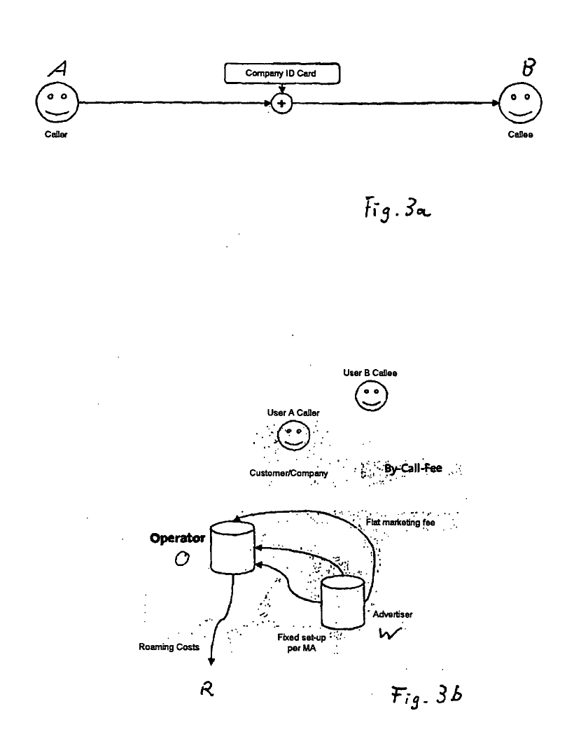

FIGS. 3a and 3b show a second preferred example of the method;

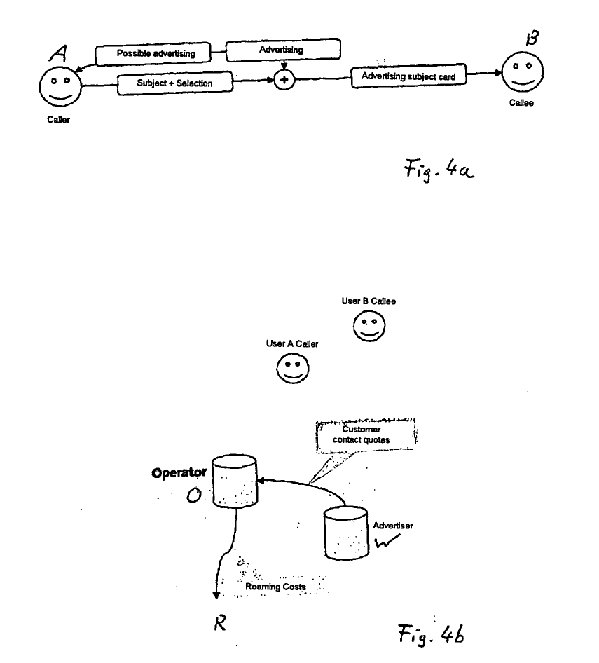

FIGS. 4a and 4b show a third preferred example of the method;

FIGS. 5a and 5b show a fourth preferred example of the method;

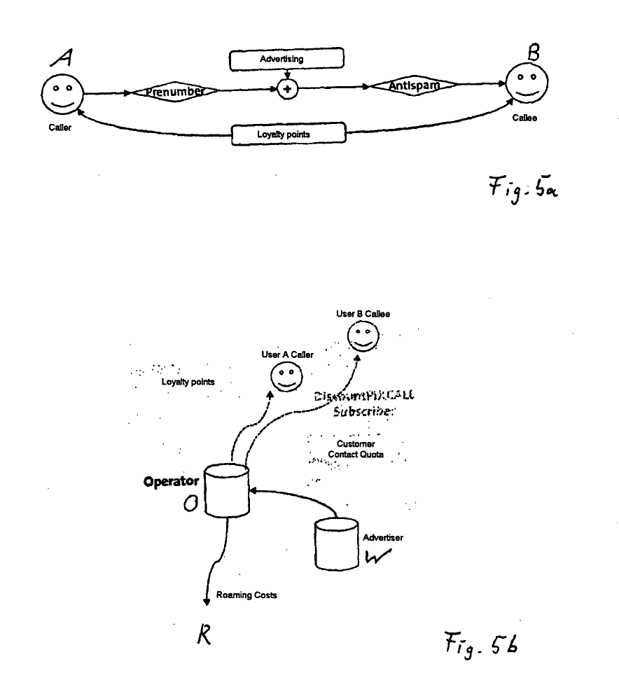

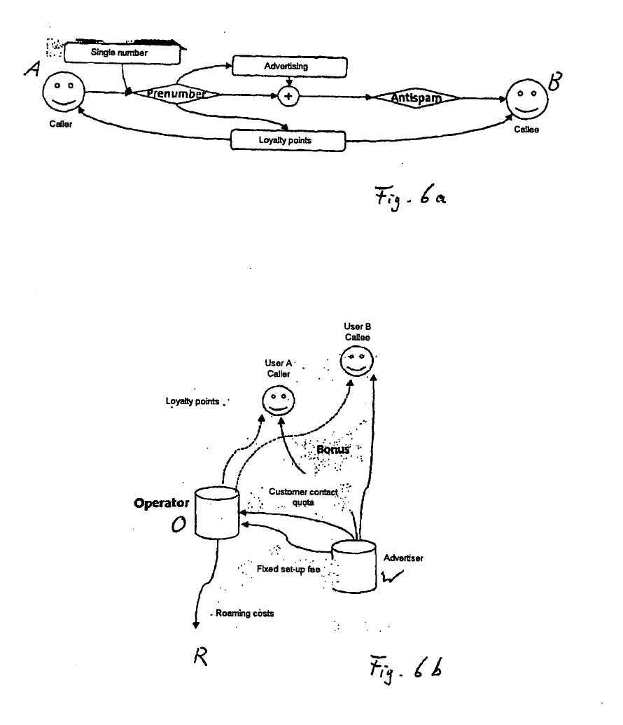

FIGS. 6a and 6b show a fifth preferred example of the method;

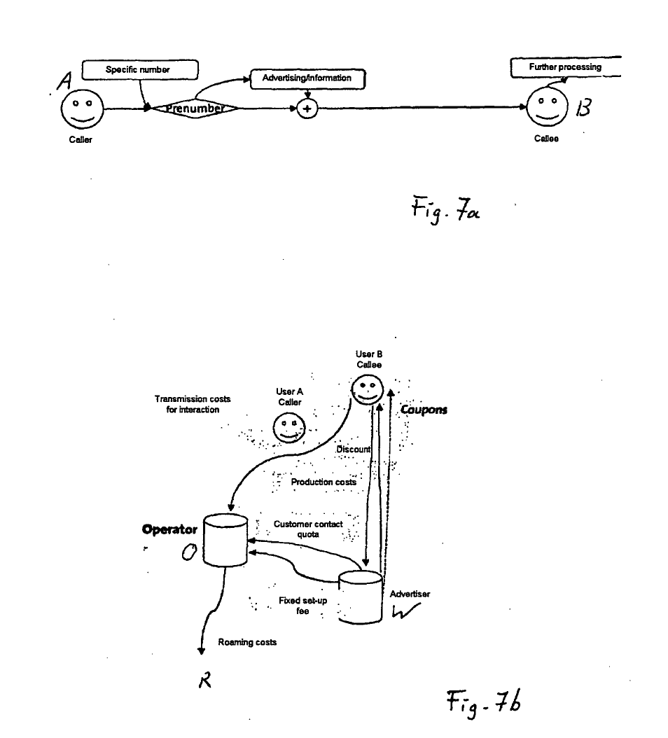

FIGS. 7a and 7b show a sixth preferred example of the method;

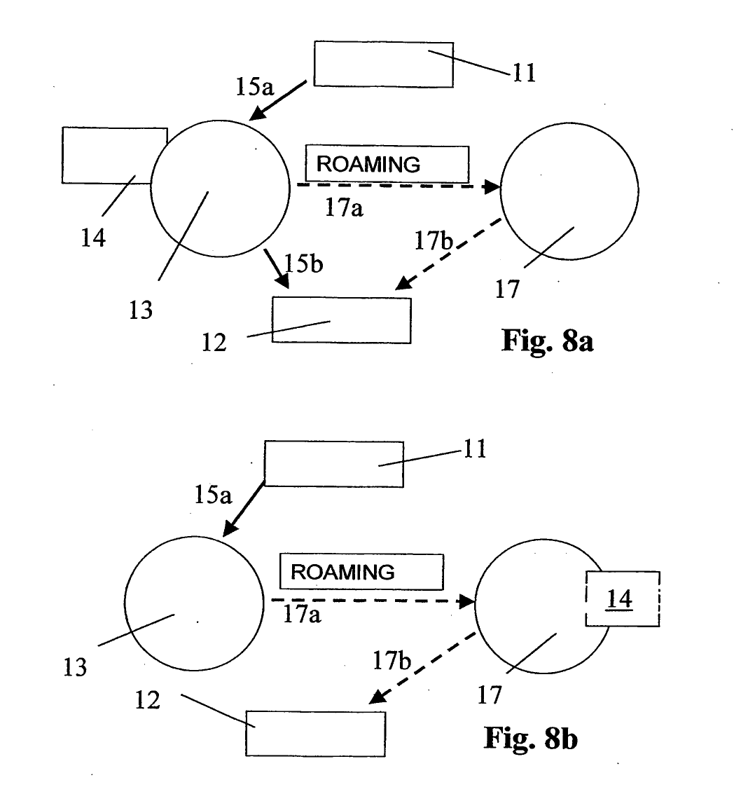

FIG. 8a shows diagrammatically the generation of additional information in the communication network of a caller when both user stations belong to the same provider;

FIG. 8b shows diagrammatically the generation of additional information in the communication network of a roaming partner when both user stations belong to the same provider;

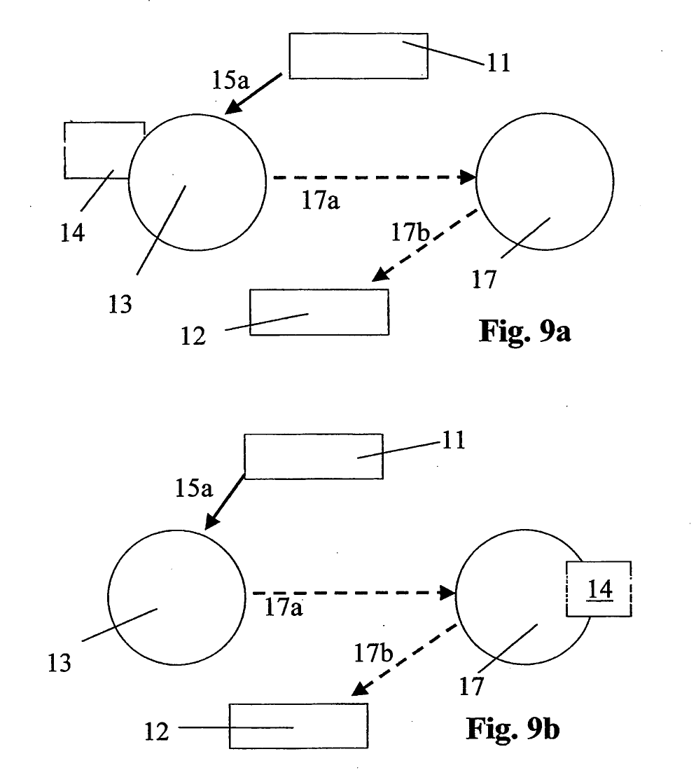

FIG. 9a shows diagrammatically the generation of additional information in the communication network of a caller when both user stations belong to different providers and calls are made in this country;

FIG. 9b shows diagrammatically the generation of additional information in the communication network of a called user when both user stations belong to different providers and calls are made in this country;

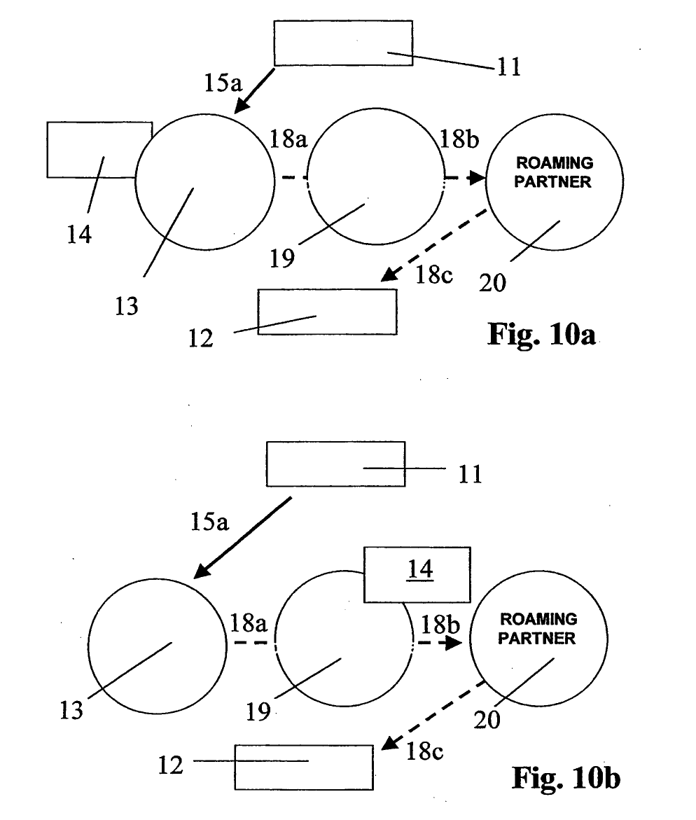

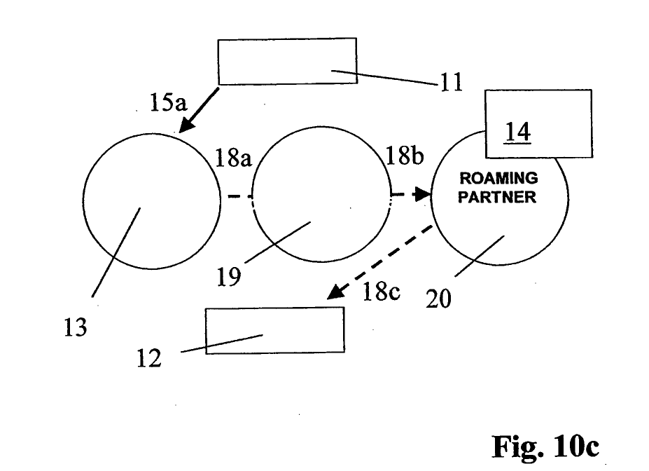

FIG. 10a shows diagrammatically the generation of additional information in the communication network of a caller when both user stations belong to different providers and calls are made abroad;

FIG. 10b shows diagrammatically the generation of additional information in the communication network of a called user when both user stations belong to different provides and calls are made abroad;

FIG. 10c shows diagrammatically the generation of additional information in the communication network of a roaming partner when both user stations belong to different providers and calls are made abroad;

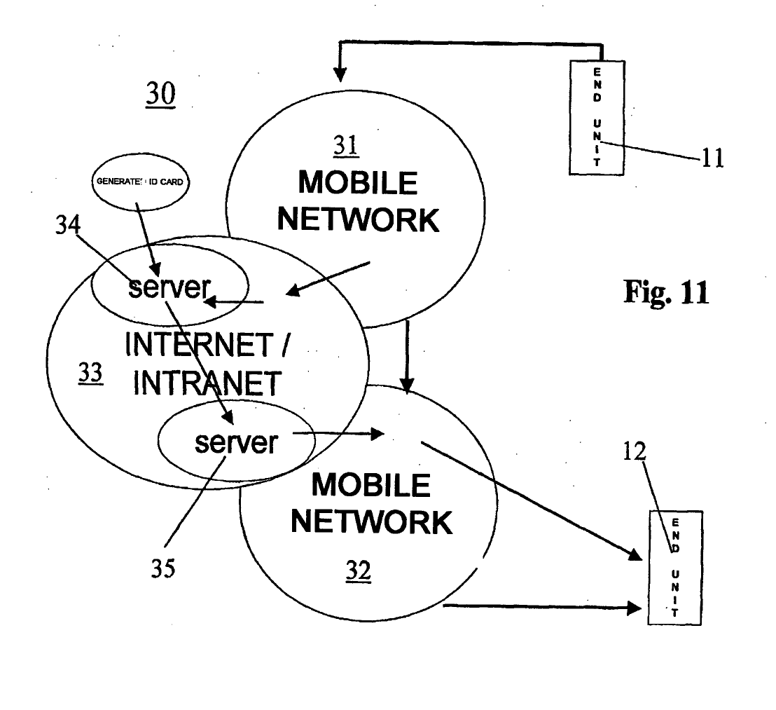

FIG. 11 shows diagrammatically a communication system according to a second advantageous embodiment of the invention in which the Internet and/or an Intranet is part of the communication system; and

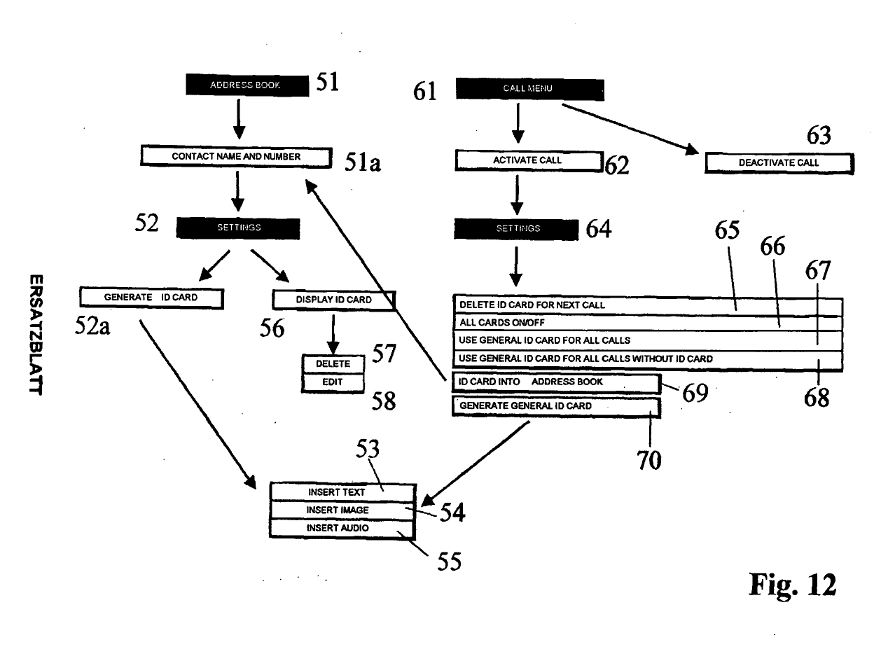

FIG. 12 represents diagrammatically the process operation and suitable menu commands on the display of a user station.

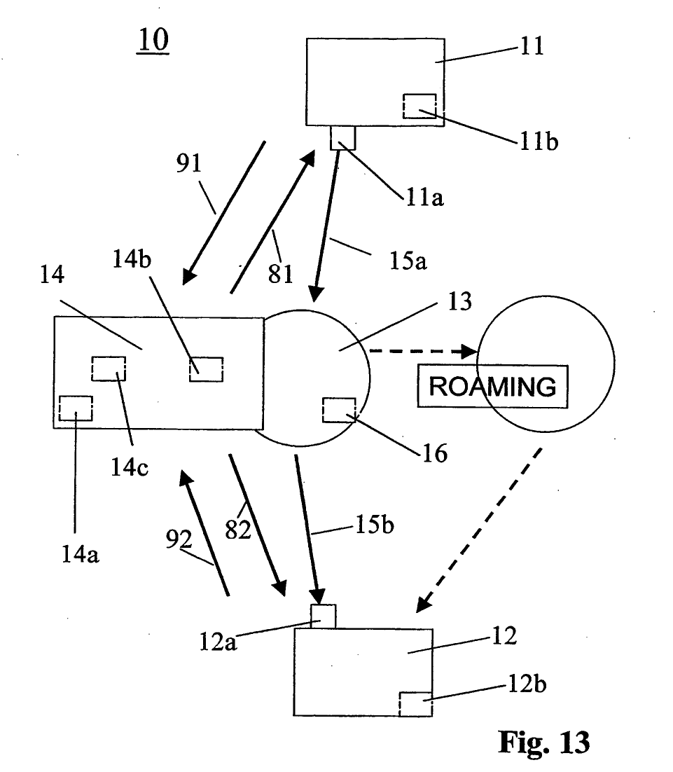

FIG. 13 shows diagrammatically a communication system according to a third preferred embodiment of the invention with which the communication process according to the invention can be carried out;

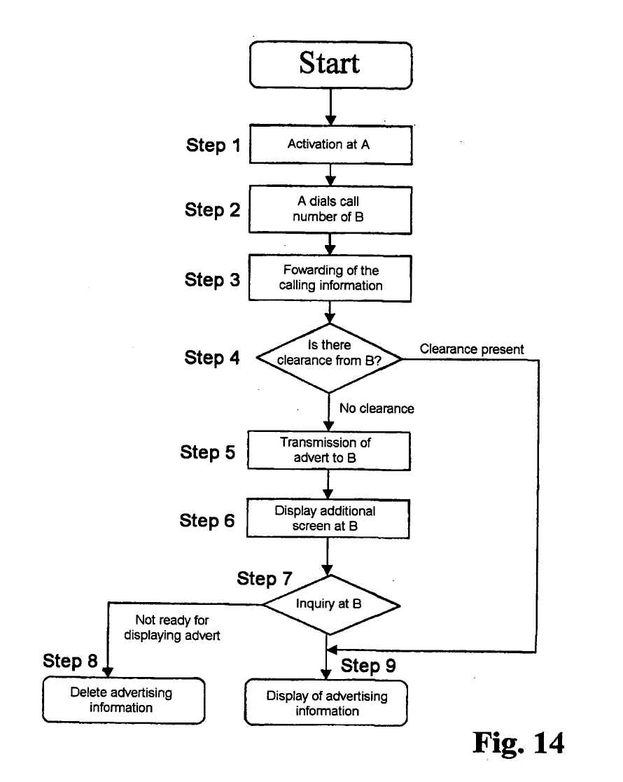

FIG. 14 shows diagrammatically the process of a communication method according to the invention with reference to an example in which query data are sent to the callee;

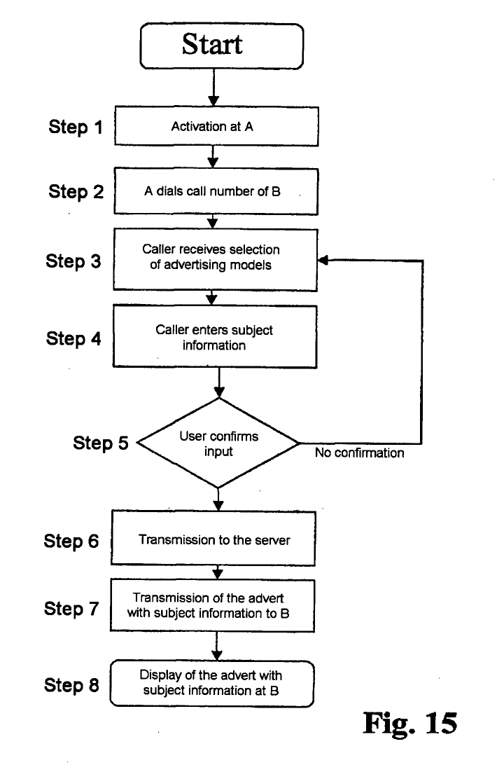

FIG. 15 shows diagrammatically the process of a communication method according to the invention according to a further embodiment in which query data are sent to the caller;

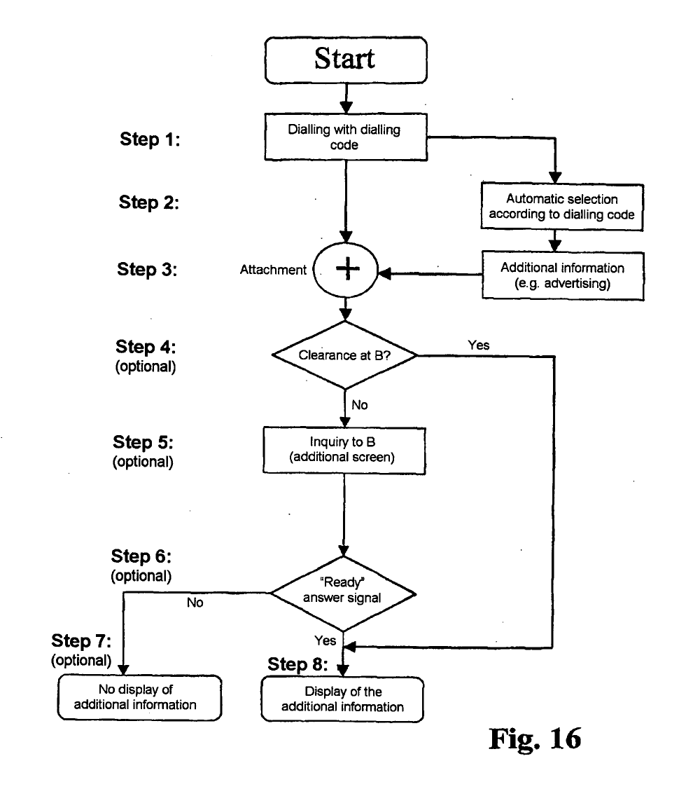

FIG. 16 shows diagrammatically the process of a communication method according to another embodiment in which the number is dialled with a prefix;

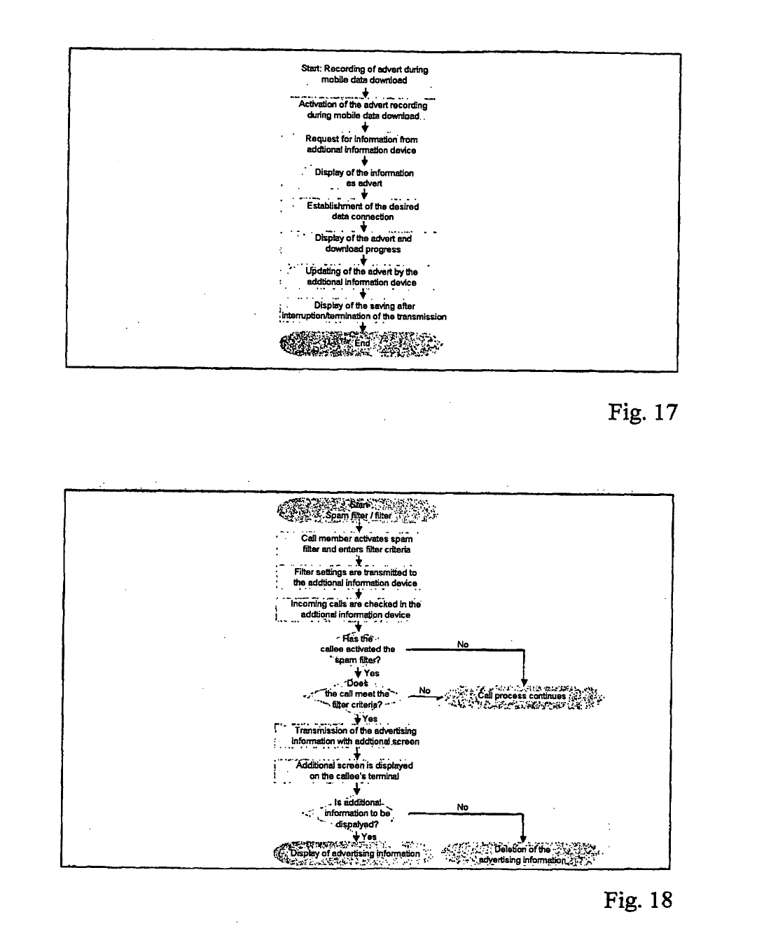

FIG. 17 shows diagrammatically the recording of advertising in the mobile data download according to the invention;

FIG. 18 shows diagrammatically the process of the method according to an example in which a spam filter is provided;

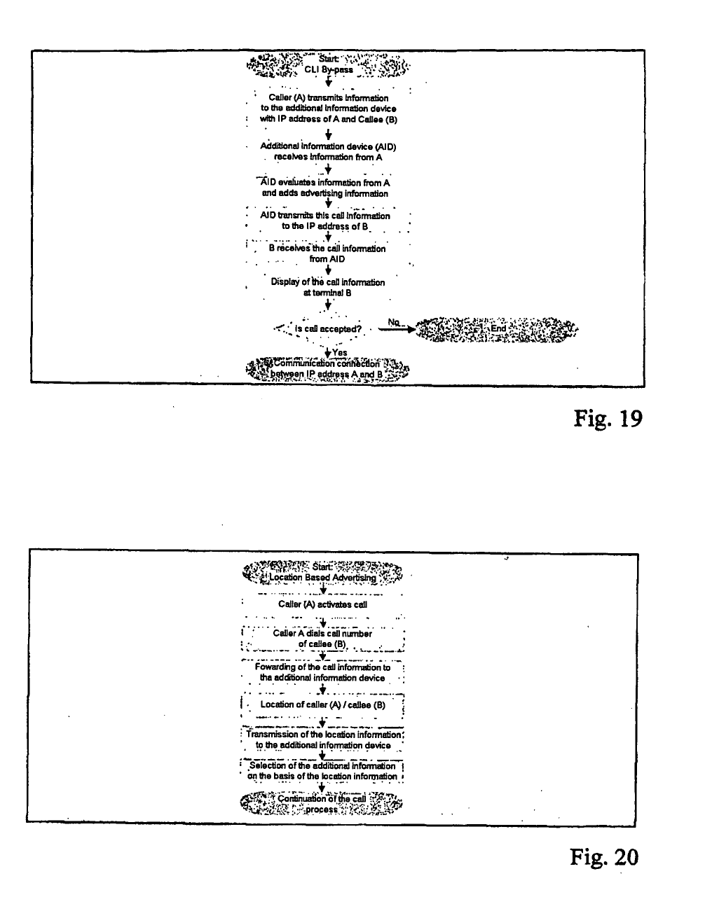

FIG. 19 shows diagrammatically the process of the method in a network which is based on Internet protocol numbers or IP numbers;

FIG. 20 shows diagrammatically the process of the method According to a further example in which location-based advertising is carried out;

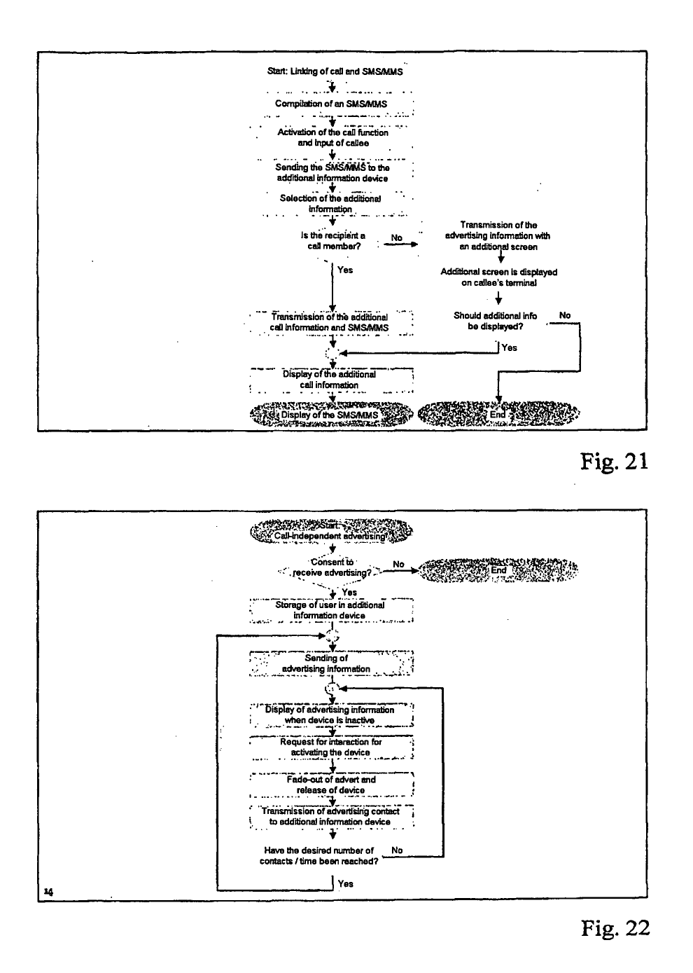

FIG. 21 shows diagrammatically the process according to a further example in which there is a link to SMS/MMS;

FIG. 22 shows diagrammatically the process of the method according to a further example in which call-independent advertising is carried out.

FIG. 1 shows a communication system 10 according to a first preferred embodiment with which the method according to the invention can be carried out. A plurality of user stations belong to communication system 10. For a simpler representation only a first user station 11 and a second user station 12 are shown. User stations 11, 12 are, for example, mobile radio units or mobile telephones, PDA's, laptops, personal computers, fixed network telephones or generally any type of communication device with an interface 11a, 12a with a communication network 13. User stations 11, 12 are each operated by one user.

Connections are established between user stations 11, 12 by means of communication network 13 in order to transmit speech, data and generally a wide variety of information from one user station to the other, or to exchange the same bidirectionally. Communication network 13 is linked electronically to an additional information device 14, and is connected to the latter so that data in the form of additional information from additional information device 14 can be linked to the connection between user stations 11, 12.

The additional information is stored in an additional information memory 14a of additional information device 14, wherein a large quantity of different additional information is stored in the form of data packets. The additional information includes, for example, adverts which include multimedia data, or individual image, text, speech, audio and/or video data. In an address memory additional information is linked to addresses or user identification numbers or codes so that the additional information is allocated to certain users.

Furthermore, a large quantity of additional information can be stored in additional information memory 14a for each user or for each user station 11, 12, which information is transmitted sequentially or randomly, or according to a predetermined process pattern, to each user.

User stations 11, 12 each have a data memory 11b, 12b, in which a wide variety of data, in particular text, image, audio and/or video data or generally multimedia data can be stored. In this case the data may be stored in the form of data sets in a format which allows a representation as individual data cards, which are called ID cards.

The individual data cards or ID cards may contain, for example, texts and associated images and are linked to tone sequences, audio and/or video data. For example, a user at his user station 11, 12 can store an ID card with a photograph of himself, the photograph can be provided with a welcome text and he can store an appropriate piece of music for this. The ID cards can be loaded, received, edited, stored and/or sent by means of a processor.

In this case a large number of ID cards can be stored in the appropriate memory 11b, 12b of the associated user station 11, 12. User numbers or user identification numbers or codes are allocated to the ID cards, which numbers are in the address book memory of user station 11, 12. Therefore an associated, stored ID card can be sent there individually when another user is selected. However, a general ID card may also be supplied for sending to all the callers to whom no special individual ID card has been allocated.

The communication network comprises an exchange arrangement with an exchange device 16 which establishes a communication connection 15a, 15b to the second user station 12 when a call set-up signal is received from the first user station 11.

An example of a first preferred application of the method is explained with reference to FIG. 2a and 2b. The arrows in FIG. 2b show the payment flow and cash flow in the business transaction:

The caller or first user A at the first user station 11 (see FIG. 1) sends a pre-generated ID card to the callee or second user B. The pre-generated ID card is linked with advertising and is sent together with the advert to callee B, which is added on the transmission path. If callee B is a member of the service or is activated for this, the ID card is indicated on his display, alternating with advertising. If he is not a member, an inquiry is carried out at him whether the ID card is to be indicated. For example, the caller must be a member to be able to use the service. The user incurs no extra costs because of cross-financing by means of advertising. On request, the user may prevent the connection of advertising in which he pays a by-call fee or additional fee when making the call, e.g. by means of a dialling code.

Operator O or the operator of the service or communication service receives money from advertiser W and/or the by-call fee from caller A, and in the case of roaming connections he pays money to a roaming partner R.

An example of a second preferred application of the method is explained with reference to FIGS. 3a and 3b. The arrows in FIG. 3b show the payment flow in the business transaction.

Caller A establishes a connection, a speech connection, for example, to callee B. The ID card of a company or a company ID card is stored in the separate or central additional information device 14 as additional information, and is transmitted together with the call set-up to the callee. For example, a company purchases this service. Whenever an employee makes a call, the personal company ID card is also sent. Companies can therefore generate an information added value for its customers, and can also improve its image. This method is particularly advantageous in the service sector.

Operator O receives from advertiser W one or more of the following cash flows: by-call fee, marketing flat fee or lump sum set-up fee. In the case of roaming connections money is paid to a roaming partner R.

An example of a third special application of the method is explained with reference to FIGS. 4a and 4b. The arrows in FIG. 4b show the payment flow in the business transaction.

Caller A or the first user may select a certain advert from different advert models. Caller A individualises the advert with his personal subject by inserting or entering an additional text in the advert. The advertising subject card thus generated is sent to callee B in the call set-up, as a result of which users may send attractive visual messages free of charge. The user incurs no additional costs as a result of the call.

Operator O receives a cash flow from advertiser W according to the customer contacts, or for certain customer quotas. In the case of roaming connections, further money flows from operator O to roaming partner R.

An example of a fourth special application of the method is explained with reference to FIGS. 5a and 5b. The arrows in FIG. 5b show the payment flow in the business transaction.

Caller A dials a certain dialling code or additional number. An advert is then displayed to callee B. For each such call both users receive one or more bonus points which can be redeemed later by means of the mobile radio.

For example, every telephone call that is made by means of the dialling code is rewarded with one loyalty or bonus point. Several loyalty points collected provide a certain number of free call minutes.

Operator O receives a cash flow from advertiser W according to the customer contacts, or for certain customer quotas. In the case of roaming connections further money flows from operator O to roaming partner R.

An example of a fifth special application of the method is explained with reference to FIG. 6a and 6b. The arrows in FIG. 6b show the payment flow in the business transaction.

In this case products are provided with individual bonus dialling code numbers. Caller A uses these numbers, for example, by dialling a suitable dialling code, thereby causing product-related advertising to be sent to callee B.

In return caller A and/or callee B receives product-specific loyalty points which they can redeem later. The bonus or loyalty points which are referred to in this connection as money, are received from advertiser W and/or operator O.

This method is of particular interest to brand-aware consumers. For example, products such as food, semi-luxury commodities, newspapers and magazines, sports articles and many other things can be requested by the user.

With the bonus system every telephone call which is made by means of the product-specific dialling code or additional number, can be rewarded with one or more loyalty points. For example, the caller receives two loyalty points and the callee receives one loyalty point. The loyalty points can then be redeemed by means of an SMS directly from the advertiser in return for fan articles or product benefits.

Operator O receives a cash flow from advertiser W according to the customer contacts, or for certain customer quotas, and/or a lump sum set-up fee. In the case of roaming connections further money flows from operator O to roaming partner R.

An example of a sixth special application of the method is explained with reference to FIGS. 7a and 7b. the arrows in FIG. 7b show the payment flow in the business transaction:

Caller A can attach certain information as content to his call by using a certain dialling code or additional number, for example the announcement of a new cinema film, which is transmitted to callee B as additional information in the form of an ID card with text and image content. Callee B sees this content or the advert displayed and is able to process it further, for example to receive a discount at the cinema box office, or when purchasing a certain product.

This special method is particularly suitable for consumer, entertainment and information conscious user groups or communities. Adverts are preferably placed with this method for newspapers, magazines, CD's, music titles, cinema and TV highlights, as well as for product highlights.

The advertising information concerned is transmitted free of charge to the callee by means of the product-specific dialling code or additional number. He receives for this a discount on an order or coupons for a direct purchase.

Operator O receives a cash flow from advertiser W according to the customer contacts and/or for certain customer quotas, and/or a lump-sum set-up fee. Where there is interaction with user B, operator O receives money for the transmission costs from user B. In the cases of roaming connections further money flows from operator O to roaming partner R.

Further designs and examples of the method are explained in detail in the following with reference to FIG. 1.

In carrying out the method according to the invention user A establishes at first user station 11 a communication context, for example in the form of communication connection 15a, 15b to the second user B at the second user station 12, for example to transmit data or mutually exchange data, or to establish a speech connection. The additional information, for example in the form of advertising, is already transmitted to the second user B in the call set-up. The additional information can be indicated on the display of user B during the first ring tone or calling signal.

When a communication connection 15a, 15b to the second user station is established from the first user station 11 via communication network 13, the user identification code of the callee, in this case the second user station 12 is first tested in exchange device 16 of communication network 13. This takes place when a call set-up signal is received from the first user station 11.

Then it is checked whether the second user station 12 has declared its consent to receive additional information. This information is contained in a selection function. A readiness to receive additional information is normally carried out by a corresponding clearance at the provider or communication service supplier.

When the second user or callee is activated according to the selection function, the additional information is called from additional information memory 14a according to the user identification of the called user station 12 and transmitted together with the call set-up signal to the second user station 12. For this purpose the additional information is linked to the user identification. The additional information is linked to the data packet sent from the first user station 11.

If there is no clearance for the second or called user according to the selection function, no additional information is called from additional information memory 14a according to the user identification of the called user station 12, and only the call set-up signal is sent to the second user station 12, so that the connection between the first and second user station 11, 12 is made without the switching or connection of additional information.

For example, an ID card can be sent from the first user station 11 to the second user station 12, which card is already contained in the call set-up signal or in a text message or general SMS, or is linked to it. The ID card is in any case sent to the second user station 12, regardless of whether there is a clearance for the second user station 12. The clearance is only a precondition for sending and/or generating ID cards.

If the second user station 12 is activated the ID card sent there by the first user station 11 is indicated on the display together with the additional information when the call enters the second user station 12. For this purpose the additional information and ID card are displayed or reproduced alternately, wherein the additional information is or may advantageously also be in the ID card format.

After the connection has been terminated the additional information remains on the display of the second user station 12, i.e. the reproduction of the additional information remains on the screen as long as no further call is received. When a further call is received the next additional information may be sent to user station 12 and reproduced there.

To facilitate the generation of ID cards they may also be generated on another device, then loaded into the user station. In particular, therefore, image and speech files may be loaded from the personal computer or via incoming short messages (SMS's) into the user station, whilst text and speech files are generated at the user station, for example.

Because of the clearance to receive adverts, a generating function is activated for free of charge generation of ID cards. Adverts may then be attached by the provider or his project partners to the calls of the user. The callee at the second user station 12 receives alternately, at 3 second intervals, for example, the ID card of the caller and the advert. The advert remains there on the display after it is received by the second user station 12 and mutates to a screen saver after the call interrupted. It remains unchanged until the next call is received.

If the ID card function is not activated the user may not generate his own ID cards and he will receive no advert but will receive the ID cards of the caller.

The function may be covered globally by international roaming processes. This provides the possibility of a closed system in which each provider or service supplier connects advertising, i.e. adverts are attached to calls received from his customers. However, an open system is also possible in which the callee concerned receives the advert from the provider of the caller.

In the communication system shown in FIG. 1 additional information device 14 of the network operator of communication network 13 connects the additional information to the calls coming from the first user station 11, and forwards the call with the attached additional information to the second user station 12. Here it is also possible for all the information to be sent via an operator of an external network 17 and a roaming connection 17a, 17b to the second user station 12 instead of via the forwarding connection 15b in communication network 13 of the provider.

When activated, the second user station 12 receives the call recognition of the first user station 11, as well as the ID card from the first user station 11 and the advert contained in the additional information. In this case separate ID cards are also generated at the second user station 12 and sent from there. The service is in the activated condition.

If there is no clearance the user at the second user station 12 receives the call recognition or user identification, together with the ID card from the first user station 11, but with no advertising or other additional information. In this case no ID card can be generated at or sent from the user station 12.

To illustrate this FIGS. 8a and 8b show a communication system in which both user stations 11 12, belong to the same provider.

In this case FIG. 8a shows the case where additional information device 14 generates and attaches the additional information in communication network 13, to which the caller or the first user station 11 belongs. The advert generated by the network operator of the caller is received at the second user station 12. In this case the connection can be established either directly by communication connection 15a, 15b of the operator of communication network 13, or by roaming connection 17a, 17b supplied by the operator of external network 17.

In FIG. 8b the connection runs in similar fashion via roaming connection 17a, 17b supplied by the operator of external network 17. In this case, however, additional information device 14 forms part of external network 17. This means that the operator of external network 17 generates adverts and attaches them to the call in the roaming process. The advert generated by the roaming partner is received at user station 12.

FIGS. 9a and 9b show a communication system in which both user stations 11, 12 belong to different national providers and calls are made nationally.

Here FIG. 9a shows the case where additional information device 14 generates and attaches the additional information in communication network 13 to which the caller or the first user station 11 belongs. The advert generated by the network operator of the caller is received at the second user station 12. Here the connection is established by means of connection 17a, 17b supplied by the operator of external network 17.

In FIG. 9b the connection runs in similar fashion via connection 17a, 17b supplied by the operator of external network 17. In this case, however, additional information device 14 forms part of external network 17. This means that the operator of external network 17 generates adverts and attaches them to the call. The advert generated by the operator of the communication network of the callee is received at user station 12.

FIGS. 10a-c show a communication system in which both user stations 11, 12 belong to different national providers and calls are made internationally.

Here FIG. 10a shows the case where additional information device 14 generates and attaches the additional information in communication network 13 to which the caller or the first user station 11 belongs. The call with the advert is forwarded via a connection 18a to the operator of communication network 19 to which the callee belongs. The call with the advert is then forwarded via connection 18b to communication network 20 of a roaming partner, and from there is transmitted via further connection 18c to further user station 12. The advert generated by the network operator of the caller is received there.

In FIG. 10b the connection runs in similar fashion. In this case, however, additional information device 14 forms part of communication network 19, to which the caller belongs. This means that the operator of communication network 19 generates adverts and attaches them to the call. The advert generated by the operator or communication network of the callee is received at user station 12.

In FIG. 10c the connection also runs in a fashion similar to FIG. 4a. In this case, however, additional information device 14 forms part of communication network 20 of the roaming partner. This means that the roaming partner generates adverts and attaches them to the call. The advert generated by the roaming partner is received at user station 12.

FIG. 11 shows a further communication system 30 according to a second preferred embodiment. Here first user station 11 is connected to a mobile network or communication network 31 via an interface. Communication connections to the second user station 12 are established by means of a further mobile network or communication network 32. The second user station 12 receives calls from the first user station 11 via communication networks 31 and 32.

There is also a connection between communication networks 31, 32 and a global network 33, for example the Internet or an Intranet. A first server station 34 in global network 33 generates additional information, which may, for example, be adverts, and supplies them for dispatch. When a caller signal is received from user station 11 in first communication network 31, server station 34 queries whether such additional information or data packets are available for connection. If this is the case, corresponding data are transmitted to a further server station 35, which belongs to the area of the callee.

It is then checked whether the selection function for receiving additional information has been activated by the recipient, which is user station 12, i.e. whether there is a corresponding clearance. In this case the additional information, e.g. adverts or other messages, is attached in the form of data or attached to the data flow deriving from the first user station 11.

Additional information, e.g. adverts, can also generally be sent and renewed without a received call, with the consent of the user, in a constant condition of readiness, i.e. in the always-on operation, e.g. in the wireless local area network (WLAN), GPRS or I-mode operating modes. Here free access to contents and services may be provided, for example, a well as the possibility of useful downloads or of generating one's own additional information at a call or communication recipient.

FIG. 12 shows diagrammatically an example of the operating process and corresponding menu commands on the display of a user station 11, 12.

An address book entry 51a, with the name and number of a user, is called by means of an address book command 51. Either an ID card can be generated or an ID card displayed by means of a setting command 52. An ID generating command 52a is used for generating an ID card, which is followed in turn by a submenu with the commands “Insert Text” 53, “Insert Picture” 54 and “Insert Audio” 55. An ID card display command 56, with an associated submenu which contains the commands “Delete” 57 and “Edit” 58, is used for displaying an ID card.

The commands “Activate” 62 and “Deactivate” 63 are accessed via a function selection command 61. The selection function can therefore be switched on and off for receiving adverts.

A further setting command 64 is used to access a submenu which contains the following commands:
65: Delete ID card for the next call;
66: Switch all the ID cards on/off;
67: Use general ID card for all outgoing calls;
68: Use general ID card for all calls received without an ID card;
69: Insert ID card into the address book
70: Generate general ID card.

Access is gained to menu command 51a, with which the address book entries are called, from menu point 69, and submenu 53, 54, 55, described above, is in turn accessed from menu command 70.

FIG. 13 shows communication system 10 described above with additional interrogation unit 14, according to a third embodiment. Interrogation unit 14b is provided for sending query data 81, 82 to first user station 11 and/or to second station 12. A selection circuit 14c serves to effect transmission of the additional informant, depending on the answer signal 91, 92 of the user station 11, 12 concerned.

According to a preferred embodiment of the method according to the invention the query data 82 are sent to second user station 12 in order to inquire whether the callee at second user station 12 would like to see further information on the current call. In this case selection circuit 14c serves either to send the additional information there, or not, depending on answer signal 92 from second user station 12. Answer signal 92 therefore contains information on whether further information is to be displayed at second user station 12. If this is not the case, only basic data of information, or only a first part of the information from first user station 11 is/are transmitted to second user station 12.

However, if answer signal 92 from second user station 12 contains the message that further information or additional information is to be displayed, selection circuit 14c effects transmission of the additional information from additional information device 14 to second user station 12.

For example, one or more adverts attached as additional information are displayed at second user station 12 alternately with supplementary data or other supplementary information sent from first user 11. This supplementary information may, in particular, contain image, video, speech, text, audio data or other data sent from first user station 11, which can preferably be displayed or are displayed in the form of a data card or ID card on the display of second user station 12. This information then supplements such basic data or information which is/are also displayed without connection of the additional information or advert. Complete multimedia data sets of first user station 11 are therefore displayed or not displayed at second user station 12, at the request of the user, for example, in the form of ID cards alternating with adverts from additional information device 14.

The communication method according to the invention may also be used when transmitting SMS or MMS messages. In this case the message or SMS/MMS message is compiled at first user station 11 and sent to second user station 12. Interrogation unit 14b of the exchange device of communication network 13 then sends query data 82 to user station 12 to inquire whether advertising is to be displayed there. If this is confirmed by second user station 12 with answer signal 92, the advert is received and displayed there as additional information in addition to the SMS or MMS message.

The advert is displayed, for example, alternately with the display of the SMS or MMS message, or even before it, within a defined period of time. In return for readiness for the additional display of advertising, the user receives certain benefits, which are stored in a benefit memory, as benefit data, assigned to the user. These benefits include, for example, a price reduction in communication costs, bonus points, free units, the possibility of transmitting and receiving ID cards, etc.

These benefits may be granted both for first user station 11, or the caller, and for second user station 12 or the callee and stored in a memory assigned to the user concerned. In particular, the callee may be informed, with query data 82, that the caller at first user station 11 is receiving a fee benefit or other benefit if the readiness to display additional information is confirmed by the callee. The benefits may also be offered to the callee himself with query data 82.

FIG. 14 shows diagrammatically, for illustration purposes, the process of the communication method according to the invention as a further example. Caller A at first user station 11 (see FIG. 13) first activates the possibility of sending a personal data card or ID card (Step 1). Caller A now dials the call number of user B at second user station 12 (Step 2). The call information is now forwarded to additional information device 14 (Step 3). There it is then checked whether second user station 12 has been activated for receiving advertising.

If there is a clearance additional information is immediately displayed at second user station 12 in the form of an advert, for example alternating with the multimedia ID card sent from first user station 11 (Step 9). If there is no clearance for advertising, query data 82 (see FIG. 13) are transmitted from additional information device 14 to second user station 12 (Step 5). Here the query data are represented at second user station 12 on a display also supplied (FIG. 6).

It is now asked whether there is readiness for displaying advertising information at second user station 12, which can be answered by a corresponding input (Step 7). For example, it is asked whether user B would like to see the ID card of caller A and additional advertising. If there is no readiness, a negative answer signal 92 is sent to additional information device 14, and the additional information is not displayed in the form of adverts. The advert is deleted or suppressed (Step 8). However, if there is readiness to receive advertising information, it is indicated on the display of second user station 12, for example alternating with the multimedia ID card sent from first user station 11 (Step 9).

Users without advertising confirmation may be addressed directly with the communication method, and may also be persuaded to participate in an ID card exchange system in return for receiving advertising. The costs of transmitting comprehensive data, multimedia data and, in particular, ID cards, may be considerably reduced.

The communication method of the invention, according to another embodiment, is explained in the following with reference to communication system 10 shown in FIG. 13.

Here query data 81 are sent to first user station 11 in order to offer there a selection of different advertising models or additional information models, from which a specific model may be selected at first user station 11, so that it can be transmitted to second user station 12 as additional information.

The additional information model selected at first user station 11 is communicated with answer signal 91 of first user station 11 to additional information device 14, then transmitted from there to second user station 12. In addition to the information from first user station 11, additional information selected by the caller, which contains an advert selected by the caller, for example, is therefore indicated on the display of second user station 12.

The additional information models that may be selected at first user station 11 are provided with an input field in which the caller can enter his personal messages, so that in this case the personal messages of the caller are linked to the additional information in the input field. The additional information or advert selected by the caller is then indicated on the display of second user station 12 together with a personal text of the caller.

The additional information provided with the personal comment or with a subject of the caller is displayed, for example, alternating with the data transmitted from first user station 11. These data include, for example, personal multimedia data or ID cards which are transmitted from first user station 11 to second user station 12. A caller may therefore send his ID cards at low cost or even free of charge because they are indicated together or alternating with an advert personalised by the caller on the display of the callee or second user station 12.

For further illustration FIG. 15 shows diagrammatically the process of the communication method of the invention according to this embodiment.

First a Caller A at first user station 11 (see FIG. 13) activates the sending of data, e.g. multimedia data in the form of an ID card (Step 1). Caller A dials the call number of a caller B at second user station 12 (Step 2). Caller A now receives from additional information device 14 a selection of advertising models, each with a subject input field (Step 3). Caller A enters the subject information in the area provided (Step 4). Caller A then confirms his input (Step 5). If there is no confirmation, a further selection is possible, i.e. return to Step 3.

The selected advertising model or information on it is then transmitted with the personal subject information to additional information device 14, which is designed as a server, for example, with answer signal 91 (Step 6): the advert with the subject information is now sent to user B or to second user station 12 (Step 7). There the advert with the subject information is displayed on the display of user B (Step 8).

Because the caller selects and personalises the additional advert itself, i.e. can provide it with a personal message or recommendation, the divergence loss in advertising is considerably reduced. The advert is perceived positively and the risk of the advert being considered annoying is reduced. At the same time users can exchange multimedia data or other information at least partially financed by advertising. In particular, personal address data packets provided with photographs or other multimedia data my be exchanged and displayed as ID cards, and here the costs to the user can be considerably reduced.

Because of the declaration of readiness to receive adverts a generating function may also be activated, for example, for the free of charge generation of ID cards. Adverts are then attached by the provider or his project partners to the calls of the user. The callee at second user station 12 receives alternately, for example at 3 second intervals, the ID card of the caller and the advert, provided that he has declared his readiness for this with an answer signal. The advert remains there on the display after the call is accepted by second user station 12, and mutates to a screen saver after the call ends. It remains unchanged until the next call is received.

The function may be covered globally by international roaming processes. This provides the possibility of a closed system in which each provider or service supplier sends query data and attaches advertising, i.e. calls from his customers are provided with query data, for example, and adverts are attached to them. However, an open system is also possible in which the callee concerned receives the advert and/or query data 81, 82 from the provider of the caller.

A further example of the method is explained with reference to FIG. 13. The additional information stored in additional information device 14 contains a large number of adverts. Moreover, a large number of general information, and even individual information on individual users, generated by the user and/or selected from models, may also be stored for transmission to other users.

Selection circuit 14c is used in this example to effect the transmission of the additional information to second user station 12, dependent on an additional code or dialling code selected by first user station 11 before the call identification. Here the additional information is transmitted to second user station 12 in communication connection 15b in the call set-up signal.

The additional information contains data such as image, text, speech, audio and/or video data or generally multimedia data. Here the data are stored and can be sent in a precisely defined data format so that they can be displayed as electronic data cards or ID cards on the displays of the user stations. This means that the recipient of an ID card sees on his display graphic information or pictorial or video information which, if necessary contains additional text and/or is linked to audio signals.

However, it is possible that not only the additional information is contained in multimedia data, for example in the format of ID cards, but information from the first user station may also be present in the ID card format and displayed when received.

Query data 82 may be sent by interrogation unit 14b to second user station 12 in order to inquire whether the callee at second user station 12 would like to see further information on the current call. In this case selection circuit 14c also serves either to transmit the further information to second user station 12 or not, depending on answer signal 92 from that station 12. Answer signal 92 therefore contains information on whether further information is to be displayed at second user station 12.

If this is not the case, only basic data of information, or only a first part of the information from first user station 11 is/are transmitted to second user station 12.

If, however, answer signal 92 of second user station 12 contains the message that further information or additional information is to be displayed, selection circuit 14c effects the transmission of the additional information from additional information device 14 to second user station 12.

If necessary the information on the caller and the additional information are transmitted via one or more exchange stations by the roaming methods of prior art, as represented in FIG. 7 by the dotted line.

FIG. 16 shows diagrammatically, for illustration purposes, the process of the communication method of the invention according to a further example. The caller at first user station 11 first dials a certain dialling code before the actual call number of second user 12. This is done either by entry on the keyboard or by calling an entry in the electronic telephone directory of first user station 11 from memory 11b. Here different predetermined dialling codes can already be assigned to certain telephone directory entries of other user stations.

The dialling codes are known to the users of the communication service, for example from SMS or MMS messages or short messages, or through products which are provided with a corresponding dialling code. The dialling codes may also be made known to the users by other advertising, by announcements, cinema and TV spots and are linked, when selected, to certain benefits.

The corresponding dialling code, together with the call identification of second user station 12, are transmitted to additional information device 14 on the basis of the choice of dialling code before the call number of second user station 12.

Selection circuit 14c selects defined additional information from a large quantity of stored additional information, according to the dialling code. This additional information is, for example, an advert, or even a personal message from the caller which the latter has previously stored. The additional information is attached so that it is contained directly in the call set-up signal transmitted to second user station 12 for signalling the call. Here the additional information, which is present in the form of advertising, for example, may be selected according to the personal profile of the callee.

In the next step it is checked whether the callee is ready at the second user station to receive the additional information. This may take place either by prior clearance of the second user station for receiving additional information or by means of an active inquiry immediately before the call concerned. In this case interrogation unit 14b first sends query data 82 to second user station 12. The transmission of additional information to the second user station is then allowed or suppressed, according to answer signal 92 of second user station 12 in response to the query data.

The checking of readiness to receive additional information is optional, i.e. the method can also be carried out without this checking. If the sending of advertising as additional information to second user station 12 is arranged by first user station 11 by pre-selection, this additional information is personalised or a personal message is sent by the caller in order to draw attention to certain products, services, cinema films, restaurants or other things which the callee would probably like to receive as information, or which his mobile radio shows in a representative condition which is associated with an image evaluation of the user.

In return for readiness for the additional display of advertising or for the use of the dialling code when dialling, user or users 11, 12 receive certain benefits which are stored as benefit data in a benefit memory assigned to each user. These benefits include, for example, a price reduction in communication costs, bonus points, free units, the possibility of transmitting and receiving ID cards, etc. The bonus points may also be redeemed later by a terminal device or a user station.

These benefits may be granted both for first user station 11, or the caller, and for second user station 12 or the callee. In particular, the callee may be informed, with query data 82, that the caller at first user station 11 or the callee himself is receiving a fee benefit or other benefit if the readiness to display additional information is confirmed by the callee.

If there is readiness to receive the additional information at second user station 12, one or more adverts attached as additional information, for example, may be transmitted to second user station 12 in the call set-up signal. There they are already displayed when the call set-up signal is received. This means that adverts are indicated as pop-ups on the display of second user station 12 when a call is received. In return the caller of first user station 11 and/or the callee at second user station 12 receives one or more bonus points which may be redeemed by mobile radio, for example.

The additional information is displayed at second user station 12, alternating for example with supplementary data or other information sent from first user 11. This supplementary information may, in particular, contain image, video, speech, text, audio data or other data sent from first user station 11, which can preferably be displayed or are displayed in the form of a data card or ID card on the display of second user station 12. In this case complete multimedia data sets of first user station 11 are therefore displayed at second user station 12, for example, in the form of ID cards alternating with adverts from additional information device 14.

The communication method according to the invention may also be used when transmitting SMS or MMS messages. In this case the message or SMS/MMS message is compiled at first user station 11 and sent to second user station 12, the dialling code also being dialled here. If there is readiness to receive additional information, the additional information, advertising, for example, is received and displayed there in addition to the SMS or MMS message.

FIG. 17 shows diagrammatically the recording of advertising in the mobile data download according to another aspect of the invention. Here a data connection is established between the terminal device and the additional information device, and advertising information is obtained. The data are then either downloaded via a further data connection to the actual file server, or these data are obtained via the data connection to the additional information device (in this case the device serves as a Proxi server). The advertising information transmitted are also printed out at the terminal device, just as a display of the download status of the data required. After a defined unit of time new advertising information is requested by the additional information device and displayed at the terminal device. The additional information device is connected to the settlement system of the network operator. A corresponding settlement mode for the user is activated with the information transmitted from the additional information device.

The user is entertained or preoccupied by the advertising during the download time and is offered favourable transmission rates by allowing advertising.

Further aspects of the invention are described in the following, where a call or the establishment of a communication connection by the method according to the invention is also referred to as a “call”. Users who are activated for the use of the method of the invention, or who have declared that they agree to receive additional information, are also referred to as “member” or “call-member”. Information with attached additional information is also referred to as “call information” or “additional call information”.

FIG. 18 shows diagrammatically the process of the method according to an example in which a spam filter is provided for preventing unwanted advertising.

When calls are received, it is checked in the mobile terminal device, or even in the network of the provider (e.g. additional information device), on the basis of the settings of the spam filter, whether the additional information (advertising) is to be displayed or blocked. The criteria for such a spam filter may here be:
1. Caller is present in the own address book
2. Caller belongs to a specific group in the own address book (e.g. friend/family only may send advertising)
3. the service is activated for callers in the own address book
4. Time of the calls (e.g. advertising-linked calls from 1800-2300 hours only).
5. Location of the callee or caller.
6. Clearance/blocking of certain advertising subjects (e.g. no cigarette advertising, no adult advertising, or scenic advertising only).

The method according to this example protects the individual user from being bothered with too much advertising. Moreover, the acceptance of the method can be increased by the use of such a process. Efficient child protection may also be achieved by means of this method.

In the method according to the invention the attachment of the additional information can be triggered by different kinds of signals, for example by the call line identifier (CLI), or can even be associated with the transmission of other information, particularly in the case of IP-based networks.

FIG. 19 shows diagrammatically the process of the method in a network which is based on Internet protocol numbers (IP) or IP numbers.

In the case of IP-based networks the user links a fixed, allocated or agreed IP number (in most cases still IPv4, in future IPv6) or any other code to the function of the associating characteristic. Every data packet transmitted contains the code of the sender and recipient, or both.

This information can also be used for linking certain data sets (e.g. in the address book) to the caller or callee and initiating actions. Therefore the method of the invention may also be used with IP numbers instead of the CLI. Such an IP-based solution may be implemented in different variations:
a. Voice communication runs via a cable-based communication connection (for example via a mobile radio network such as GSM or a stationary telephone network such as PSTN). However, the data transmission of the ID cards is carried out via a packet-based communication connection (for example GPRS)—the IP number in the method is then used for this purpose.
b. Voice and data communication is carried out via an IP-based network (IP and voice-over-IP), e.g. on the Internet, Intranet, WLAN, TV cable, satellite, power mains (PC to PC), or in IP-based telecommunication networks (mobile and fixed network).

The method can therefore also be used both in IP-based networks and in voice-over-IP telecommunication networks, or on the Internet. This broadens the scope of the method enormously.

Viral expansion is explained in the following according to another aspect of the invention. Here calls to non-members of the service are to be used to win them as members. Being a member means that the user declares that he has agreed to receive additional information or has been approved to make his own use of the communication service.

If a non-member receives a call and obtains data, e.g. in the form of an ID cad, he experiences the benefit live and can therefore evaluate his own personal use. After he has ended he goes over to another advert to participate which explains the benefits of membership to the user. Using a dialogue field the user is able to become a member immediately or interrupt the process. If the user wants to become a member, further information is requested from him, is sent to the server of the communication service and stored there.

Consequently the communication channel created by the invention can be used to spread the own service (viral marketing effect). The method provides the user with a simple, efficient possibility of activating the service.

An extremely powerful advertising effect is achieved thereby, because substantial market penetration can quickly be achieved. In addition, the quality of the advertising contacts improves the more information is available on the individual user. Personal data can only be stored by members.

FIG. 20 shows diagrammatically the process of the method according to a further example in which location-based advertising takes place. However, in order to be able to address customers on a context-related basis, for example to stimulate impulse purchases, not only the profile but also the current location of the users is also included here.

For example, there is advertising selection related to the location of the caller.

In the mobile communication network information on the location of the caller (determined by the cell ID or another location process) is transmitted to the additional information selection device. This device selects a suitable advert on the basis of the location information and transmits it to the callee by the method according to the invention.

Consequently advertising may be selected on the basis of the present location of the caller. Special location-related services can be provided by this method: Inside a conference centre calls according to the invention can be made at a cheaper rate because of the conference centre advertising. The advert is then associated with the call content, for example.

Advert selection may also be related to the location of the callee:

In the mobile communication network information regarding the location of the callee (determined by the cell ID or another location process) is transmitted to the additional information selection device. This device selects a suitable advert on the basis of this location information and transmits it to the callee according to the method of the invention.

Consequently divergence losses in advertising are minimised and advertising success is maximised. Advertising may therefore be used as target-specifically as possible. Because of the storage of profiles users can be targeted specifically for their preferences using the method of the invention. Advertising can be selected based on the location of the caller. The callee can be addressed with advertising from his proximity. Therefore impulse purchases can be stipulated in the same way as short-term campaigns, for example (e.g. 30 cinema tickets left for the film in one hour).

FIG. 21 shows diagrammatically the process of the method according to a further example in which a link is made to SMS/MMS.

The SMS/MMS is linked to the function according to the invention in the same way as the voice call. The SMS/MMS is compiled and a call is then triggered by software, hardware or a dialling code, with the attachment of additional information. The SMS or MMS is sent and an advert is added in the mobile communication network by triggering in the additional information device. The advert, alternating with the SMS/MMS, is indicated on the display of the callee, according to the design of the method and its member status.

According to another example the advertising information is displayed for a defined time before the SMS/MMS is displayed, and no further alternation takes place.

Furthermore, the antispam solution described above can also be used in this method. The user receives an SMS/MMS and is asked before the content of the advert is displayed whether he would like to see that advert.

The method according to this example offers the user the full messaging function in the mobile environment, with the benefits of the method according to the invention, such as a price reduction for the service, bonus points, etc., and at the same time opens up a new advertising channel for the operator.

FIG. 22 shows diagrammatically the process of the method according to a further example in which call-independent advertising takes place.

A user registers with an operator via an electronic communication network (GSM, GPRS, UMTS, WLAN, Internet, Intranet, etc.), and is activated. His data are stored in the additional information device. Updated advertising information is then sent to this user at fixed or variable intervals. Either existing processes are used here, such as the sending of operator logos in mobile radio networks, or a program at the terminal device of the user (mobile telephone, stationary telephone, computer, video recorder, etc.) makes possible the display, further processing of the user feedback and management of bonus points.

For example, the mobile telephones, in the standby mode, display the operator logo or the user's own logo. This communication field is recorded or combined with commercial advertising. As long as the mobile terminal is switched on, the network operator has a connection to that terminal device. As operator logos they can be sent by SMS to the users and advertising information is received instead of the operator logo, or combined with it.

The additional information device is connected to the settlement system of the operator in order to provide the advertising consumers with benefits, such as free minutes, bonus points, free SMS, data flat fees, free downloads, etc., depending on the following criteria:
1. on the basis of his membership and/or
2. on the basis of the transmitted advertising information and/or
3. on the basis of the type of advertising information and/or
4. on the basis of the time the advertising information is displayed

Furthermore, the advertising information can be enriched with an interactive component. This interactive component sends the user feedback to the additional information device, where this information is stored and evaluated to measure advertising success. This advertising tracking information may also be evaluated in the additional information device and connected to the settlement system of the operator to determine benefits for the advertising consumer (see above) and/or the costs to the advertiser.

For example, the user receives a new advert from the additional information device at his mobile terminal device every two hours. The device emits a beeping tone, displays the advertising information transmitted and asks the user, visually or acoustically, to press a certain or any key or button on a touch-screen. The user feedback is transmitted to the additional information device and the advert disappears and the mobile terminal device resumes its normal functions.

According to another design of the method a second feedback is required for a predetermined time after the first user feedback. For example, it is added after the first feedback that a certain number key, which is selected for each random numbers generator, must be pressed to release the functions of the mobile telephone. This feedback is also transmitted to the additional information device. With the double user feedback the service operator is able to demonstrate to the advertiser that the advert has been seen for a defined period of time.

The improved advertising impact can be higher remunerated further by the advertiser by linking the evaluation of multiple user feedback to the settlement system of the operator as described above. Higher advertising prices and larger bonuses or benefits for the users are therefore achieved.

The method offers the user a cash value benefit through the consumption of advertising information. The method is extremely easy to handle for the user, and relies on existing systems. The service opens up a new source of income for the network operator and a new advertising channel for the advertiser. Advertising success can be measured by the feedback structures of the method. Thus advertising according to the method described stands out clearly from conventional advertising channels such as Print, TV etc.

The possible linking of the method according to the invention to video telephone is described in the following:

Here video telephony ready terminals are used as terminal devices. When a call is received the video stream of the telephone is displayed without sound, alternating with an advertising attachment. This “preview” may be used as a marketing instrument for the expansion of video telephony. The additional information is transmitted, for example, via the data channel of the video stream. An incoming video call therefore establishes a data connection for subsequent video transmission, and transmits the additional information or ID cards.

In connection with video telephony a considerable benefit is achieved by the method according to the invention when selecting the call partner. Calls may be selected not only on the basis of the incoming number, but also according to the subject concerned. Previously the callee had to accept a video call in order to learn the basis and/or subject of the call. This therefore reduces or avoids the disturbance of the intimate atmosphere of the user from video telephony.

The following benefits in particular are achieved by the present invention, in its different aspects and embodiments:

Multimedia data, such as electronic data cards, may be easily sent by the caller to other users without the need for special terminal devices. Furthermore, callers may individually select additional information which they would like to be sent to the callee. The additional information may be either the user's own multimedia, electronic visiting cards, data cards or ID cards of the user with which he is already represented when the call arrives on the display of the callee.

The callee enjoys the advantage that he receives visual information on the call content before he accepts the call. However, the additional information may also contain general information or adverts whose transmission gives the users fee benefits or other benefits such as the use of certain services or communication connections.

The network operator enjoys the advantage that modern communication services are increasingly in demand because of the attractiveness and possibility of financing by advertising, and existing capacities can be used and further expanded. Settlement can be made on the basis of customer contact when adverts are transmitted.

Companies and advertising agencies enjoy the advantage that target group specific marketing can easily be carried out. Adverts can be placed specifically on the basis of interests and user profiles, and the advertising can be carried out on the basis of further recommendation among the customers.

The invention makes possible data services which are transmitted by the caller during the call set-up and are shown on the callee's display during the first ring tone. The call set-up therefore becomes the innovatively designable innovation and communication channel with a high, empirical added value for the user. A high degree of acceptance is achieved because of the benefits for the subscribers or end users, giving rise to rapid viral market expansion at relatively low marketing costs. The invention is also particularly suitable as a standard service in mobile radio, which generates incomes through advertising partners. The invention helps mobile radio operators to open up a new sales channel and offers advertising partners specific targeting of customers at a time of high customer attention with comprehensible advertising success monitoring.

Turnovers can be increased with the invention, particularly in the mobile radio market, with promotion of the use of UMTS technology. Voice calls are linked to data services. The invention creates a new type of advertising channel which can be used in mobile communication for cross- and co-financing of mobile services. Mobile radio services may be offered at low cost, and additional incentives are created for the end customers. A particular advantage is that data services linked to the voice channel can be used in conjunction with mobile marketing or marketing in the mobile radio sector.

The user or subscriber can design and/or select and send personal or predetermined subject information which can be already indicated on the display of the callee during the call set-up, together with advertising information, and can therefore be easily further processed.

The information requirement of the users around the calling process is met in that preliminary information or a subject is displayed beforehand. In addition, an efficient, profitable advertising channel is created during the call set-up. Adverts can be placed specifically and an added value can be provided for the user and the advertiser. Call-lined added value services are created with simultaneous cross-financing by advertising partners. Bonus points in connection with the method according to the invention can also be granted to users. In the business customer area a premium call can be made by means of the appropriate company ID card.

The benefits for the user are essentially a new information channel and a possible bonus or additional service without extra costs. The benefits for the operator are a higher turnover and greater customer loyalty. The benefits for the advertiser are more attention within the target group, more customer contacts and measurability of target group attainment.

The benefits for the different groups may be classified briefly as follows:

Benefits for the caller:
1. added value communication channel that can be redesigned; fun and image improvement;
2. free of charge extra info/additional benefit in the calling process due to personal ID cards, subject information or selected discounttickets;
3. cross-financing of additional services—including call shares—by individually selected advertising;
4. cash value added benefit—loyalty points, free minutes, discount tickets—through the voice communication channel of prior art;
5. simple clearance by pre-number.

Benefits for the callee:
1. receipt of additional call information—ID cad, subject—when calls are received, with simple further processing; fun and image improvement;
2. direct visual information on call content (for example, subject, theme), or on the calling person (ID card) before the call is accepted. More transparency in communication, better preparation/filtering of calls;
3. cash value added benefit—such as loyalty points, free minutes, discount tickets—through the voice communication channel of prior art;
4. active and direct interaction with advertising contents

Benefits for the operator:
1. direct increase in the revenue, turnover or profit due to new standard service for end and business customers;
2. indirect increase in incomes from voice connections;
3. simple communication of the service and the beneficial aspects to the end customer and advertising partner;
4. increased customer loyalty (church rates) due to enhancement of the core product, voice communication service, with an innovative additional service;
5. use of existing core areas of competence, for example billing, accounting, network infrastructure;
6. increase in revenues due to switching advertising budgets to communication;
7. sales through existing customer relations;
8. fast target customer addressing, wide distribution, high presence with simultaneous possibility of viral marketing strategies;
9. additional sales through the redemption of loyalty points based on the operator's own bonuses;
10. additional sales through advertising, individual compensation per customer contact;
11. additional sales from setting up the pre-number system;
12. additional sales through traffic from the redemption of loyalty points or callee interaction.

Benefits for the advertiser:
1. new interaction and sales channel with high advertising attention;
2. targeted customer contacts with low divergence losses;
3. targeted advertising based on the preferences of the subscribers or customers;
4. accurate advertising success measurement and advertising feedback from customers;
5. scenario processing with viral marketing strategies;
6. individual marketing concepts possible; focus brand/image advertising extending to couponing;
7. advertising selected and personalised by the caller; conscious analysis of the advert;
8. positive charging of the advert through direct customer benefit;
9. product differentiation and additional purchase incentive;
10. positive charging through consumer control;
11. exclusive brand creation and increased customer loyalty;
12. channelling of further recommendations.

1. A method for transmitting additional information in a communication system in which a first user of a communication system establishes a communication context with a second user of the communication system, characterised in that additional information is attached during the establishment of the communication context in the communication system and is transmitted to the second user.

2-34. (canceled)
